(19) United States
(12) Patent Application Publication
(10) Pub. No.: US 2026/0248120 A1
(43) Pub. Date: Aug. 27, 2026

(54) ELECTRIC HEATING MOSQUITO REPELLER

(71) Applicant: Weiguang ZHOU, Shenzhen (CN)

(72) Inventor: Weiguang ZHOU, Shenzhen (CN)

(21) Appl. No.: 19/073,320

(22) Filed: Mar. 7, 2025

(30) Foreign Application Priority Data
Feb. 26, 2025 (CN) 2025203201307

(51) Int. Cl. A01M 1/20; A01N 25/18; A01N 25/34; A01P 17/00

(52) U.S. Cl. CPC A01M 1/2077; A01N 25/18; A01N 25/34; A01P 17/00; H01M 10/623; A01M 2200/012

(57) ABSTRACT

Disclosed is an electric heating mosquito repeller, including a housing assembly; a protective cover fixedly disposed on the housing assembly; a heating and heat-insulating assembly fixedly disposed throughout the housing assembly and disposed directly below the protective cover; and a mosquito repellent tablet detachably engaged in the protective cover and can be in close contact and connection with the heating and heat-insulating assembly. The heating and heat-insulating assembly includes a heating member that is fixedly disposed throughout the housing assembly and a heat-insulating layer that is fixedly disposed on one side of the heating member. The mosquito repellent tablet is detachably and tightly attached to the other side of the heating member opposite to the heat-insulating layer.

### CROSS-REFERENCE TO RELATED APPLICATIONS

The application claims priority to Chinese patent application No. 2025203201307, filed on Feb. 26, 2025, the entire contents of which are incorporated herein by reference.

### TECHNICAL FIELD

The present disclosure relates to the technical field of mosquito repellers, and in particular, to an electric heating mosquito repeller.

### BACKGROUND

An electric heating mosquito repeller, also known as an electric mosquito repeller, is a common household or outdoor mosquito repeller today. The electric heating mosquito repeller is mainly divided into an electric mosquito repeller liquid device and an electric mosquito repellent tablet device according to the type of the mosquito repellent used. The electric mosquito repellent tablet device in the existing technology mainly performs a mosquito repelling operation in a manner that an electric mosquito repellent tablet slot is disposed above a heating element fixed inside the electric mosquito repellent tablet device and the electric mosquito repellent tablet is fixed by limiting the space size in the slot.

The patent with the publication No. U.S. Pat. No. 6,078,728A provides a volatile carrier for supplying a volatile component to a heating device dispensed therefrom. The heating device has a through path in the form selected from the group consisting of a channel, a tunnel, a chamber, and an open slot. The through path has an end opening suitable for receiving an inserted volatile carrier so as to position the volatile carrier in a position close to the heat source of the heating device. The volatile carrier includes: a. A substantially unitary reservoir block, which contains the supply of the volatile component; and b. A one-way propulsion device by which a user can manually push a liquid storage block beyond the heat source to expose different portions of the liquid storage block to the heat. Although this technical solution can achieve the mosquito repelling operation by heating the mosquito repellent tablet through the heat source, the heat source is in double-sided heating, so only the heat on one side of the heated mosquito repellent tablet is effectively utilized, while the heat energy emitted from the other side of the heat source is wasted, resulting in a low utilization efficiency of the heat source. Especially when used outdoors, the endurance of the mosquito repeller itself is greatly affected due to the inconvenience of charging. Therefore, an electric heating mosquito repeller is provided, to solve the above-mentioned problems.

### SUMMARY

One of the objectives of the present disclosure is to provide an electric heating mosquito repeller, to solve the problem that the existing electric heating mosquito repeller has a low heat utilization efficiency.

The electric heating mosquito repeller provided by the present disclosure can be achieved by the following technical solution:

According to the present disclosure, an electric heating mosquito repeller includes a housing assembly; a protective cover fixedly disposed on the housing assembly; a heating and heat-insulating assembly fixedly disposed throughout the housing assembly and disposed directly below the protective cover; and a mosquito repellent tablet detachably engaged in the protective cover and can be in close contact and connection with the heating and heat-insulating assembly, the mosquito repellent tablet being heated by the heating and heat-insulating assembly; where the heating and heat-insulating assembly includes a heating member that is fixedly disposed throughout the housing assembly and a heat-insulating layer that is fixedly disposed on one side of the heating member; and the mosquito repellent tablet is detachably and tightly attached to the other side of the heating member opposite to the heat-insulating layer.

In one embodiment, the heating and heat-insulating assembly further includes a heat-insulating chamber that is a hollow cavity with one end opened; the heat-insulating chamber is fixedly disposed in the housing assembly; and the heat-insulating layer and the heating member are fixedly disposed in the heat-insulating chamber in sequence.

In one embodiment, the heat-insulating layer includes glass fiber wool and aluminum foil that are disposed in sequence; and the glass fiber wool is tightly attached to the heating member.

In one embodiment, the heating member includes a heating film and a heat-conducting plate; the heating film is fixedly disposed between the heat-insulating layer and the heat-conducting plate; and the heat-conducting plate can be in close contact and connection with the mosquito repellent tablet.

In one embodiment, the heating film is a thin film with a metal foil or a metal wire as an inner conductive heating element; and a size of the heating film is smaller than a size of the heat-conducting plate.

In one embodiment, a temperature-controlled resistor is attached to the heating film; and the temperature of the heating film is monitored in real time by the temperature-controlled resistor.

In one embodiment, the heating member is a ceramic heating element or a graphene heating element.

In one embodiment, the housing assembly includes a first housing and a second housing that are fixedly connected and form a closed hollow cavity and a mounting member that is disposed on the other side of the first housing opposite to the second housing.

In one embodiment, the mounting member is a snap-fit member or an adsorption member.

In one embodiment, the mounting member includes a fixing plate that is fixedly disposed on the first housing and a latch that is engaged between the fixing plate and the first housing.

In one embodiment, the electric heating mosquito repeller further includes a circuit board, a battery assembly and a key assembly; the circuit board and the battery assembly are fixedly disposed in the housing assembly, respectively; the circuit board is electrically connected to the heating and heat-insulating assembly, the battery assembly and the key assembly, respectively; and the key assembly is disposed on the circuit board and penetrates through the housing assembly.

In one embodiment, a wireless communication module is disposed on the circuit board, and a wireless connection with an electronic terminal can be established through the wireless communication module; and the wireless communication module uses one or more of a Bluetooth wireless communication module, a WiFi wireless communication module, a 4G wireless communication module and a 5G wireless communication module.

In one embodiment, the battery assembly is a polymer lithium-ion battery.

In one embodiment, the key assembly includes a key body and a key housing; the key body is fixedly disposed on the circuit board; and the key housing is disposed on the key body and penetrates through the housing assembly.

In one embodiment, the electric heating mosquito repeller further includes a charging interface and an indicator light assembly; and the charging interface and the indicator light assembly are separately disposed on the circuit board and penetrate through the housing assembly.

In one embodiment, the charging interface is a Micro USB interface, a Type C interface or a Lightning interface.

In one embodiment, a waterproof plug is detachably disposed on the charging interface, and the waterproof plug is disposed on the housing assembly at one end thereof.

In one embodiment, a first accommodating cavity and a second accommodating cavity are disposed in the first housing, respectively; the battery assembly is disposed in the first accommodating cavity; and the circuit board and the heating and heat-insulating assembly are disposed in the second accommodating cavity, respectively.

In one embodiment, a neck is disposed throughout the protective cover, and the mosquito repellent tablet is detachably engaged in the neck; and the protective cover is also provided with a plurality of hollow grooves.

In one embodiment, the mosquito repellent tablet is of a gasket structure impregnated with a mosquito repellent.

Compared with the existing technology, the beneficial effects of the electric heating mosquito repeller of the present disclosure are as follows.

The electric heating mosquito repeller provided by the present disclosure heats the mosquito repellent tablet arranged thereon through the heating of the heating member, such that the mosquito repellent on the mosquito repellent tablet volatilizes, thereby effectively achieving the mosquito repelling operation. The heating member is subjected to the heat-insulating operation by the cooperation of the heat-insulating chamber and the heat-insulating layer, such that most of the heat of the heating member is only transferred to one side of the mosquito repellent tablet, thereby greatly reducing the heat waste of the heating member and significantly improving the endurance of the electric heating mosquito repeller. The battery assembly is charged through the charging interface, such that the electric heating mosquito repeller can be recycled, which increases the service life of the electric heating mosquito repeller to a certain extent. The indicator light assembly allows users to observe the remaining power of the battery assembly in real time, and at the same time the multi-gear heating setting can be performed through the key assembly. The users can switch between different gears according to actual needs, so as to improve customers'satisfaction and experience to a certain extent.

### BRIEF DESCRIPTION OF DRAWINGS

To better clarify the technical solution of the embodiments of present disclosure, the accompanying drawings required to illustrate the embodiments will be simply described below. It is understood that the accompanying drawings described below merely illustrate some embodiments of present disclosure, so it is not a limitation to the scope. Those of ordinary skill in the art can obtain other related accompanying drawings of other embodiments without creative labor on the basis of these accompanying drawings.

FIG. 1 is a schematic structural diagram of an electric heating mosquito repeller according to the present disclosure;

FIG. 2 is a schematic cross-sectional view of an electric heating mosquito repeller of the present disclosure shown in FIG. 1;

FIG. 3 is a schematic diagram of an exploded structure of an electric heating mosquito repeller of the present disclosure shown in FIG. 1, including a housing assembly and a heating and heat-insulating assembly;

FIG. 4 is a schematic diagram of an exploded structure of a housing assembly shown in FIG. 3;

FIG. 5 is a schematic diagram of an exploded structure of a heating and heat-insulating assembly shown in FIG. 3; and

FIG. 6 is a schematic diagram of a connection structure between various electrical components in an electric heating mosquito repeller of the present disclosure shown in FIG. 1.

Reference numerals: electric heating mosquito repeller 10; housing assembly 11; first housing 111; first cavity 1111; second cavity 1112; first through hole 1113; second housing 112; second through hole 1121; key hole 1122; mounting member 113; fixing plate 1131; latch 1132; covering 114; protective cover 12; neck 121; hollow groove 122; circuit board 13; wireless communication module 131; heating and heat-insulating assembly 14; heat-insulating chamber 141; heat-insulating layer 142; heating member 143; heating film 1431; temperature-controlled resistor 14311; heat-conducting plate 1432; mosquito repellent tablet 15; battery assembly 16; key assembly 17; key body 171; key housing 172; charging interface 18; waterproof plug 181; indicator light assembly 19.

### DETAILED DESCRIPTION OF THE EMBODIMENTS

In order to make the objectives, technical solutions and advantages of the present disclosure clearer, the technical solutions in the embodiments of the present disclosure are clearly and completely elaborated below in combination with the accompanying drawings in the embodiments of the present disclosure. It is apparent that the described embodiments are a part of the embodiments of the present disclosure but not all. Usually, the components of embodiments of the present disclosure described and shown in the accompanying drawings herein may be arranged and designed in various different configurations.

Therefore, the detail description for the embodiments of the present disclosure provided in the accompanying drawings below is not intended to limit the protection scope of the present disclosure, and merely shows the selected embodiments of the present disclosure. Based on the embodiments of the present disclosure, all the other embodiments obtained by those of ordinary skill in the art on the premise of not contributing creative labor should belong to the protection scope of the present disclosure.

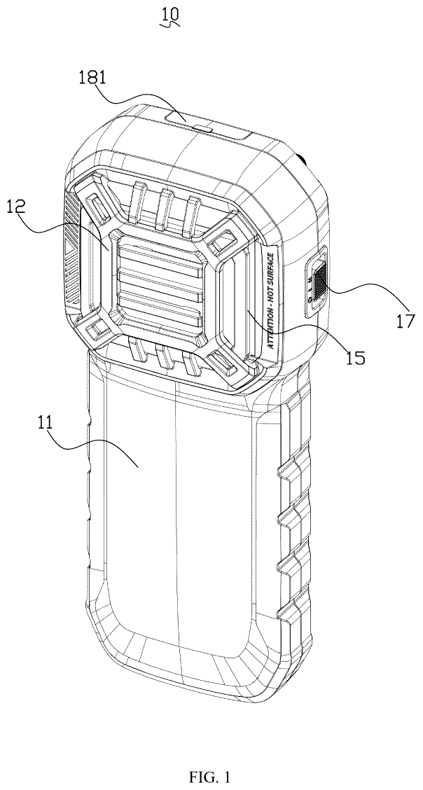

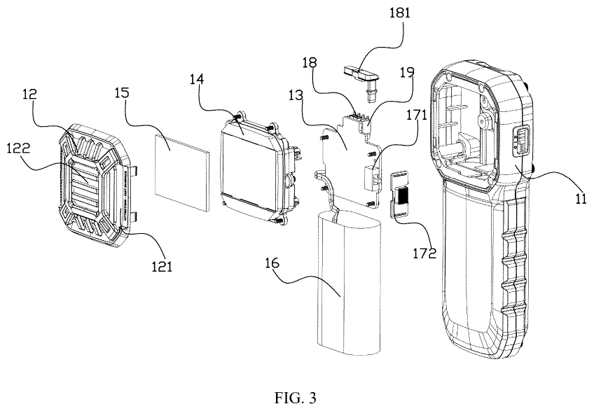

Referring to FIG. 1 to FIG. 6, an electric heating mosquito repeller 10 provided by the present disclosure mainly includes a housing assembly 11, a protective cover 12, a circuit board 13, a heating and heat-insulating assembly 14, a mosquito repellent tablet 15, a battery assembly 16, a key assembly 17, a charging interface 18 and an indicator light assembly 19. The housing assembly 11 is a hollow cavity. The protective cover 12 is fixedly disposed on the housing assembly 11. The circuit board 13 and the battery assembly 16 are fixedly disposed in the housing assembly 11, respectively. The circuit board 13 is electrically connected to the heating and heat-insulating assembly 14, the battery assembly 16, the key assembly 17, the charging interface 18, and the indicator light assembly 19, respectively. The battery assembly 16 provides electrical energy to the circuit board 13, the heating and heat-insulating assembly 14, and the indicator light assembly 19, respectively. The heating and heat-insulating assembly 14 is fixedly disposed throughout the housing assembly 11 and disposed directly below the protective cover 12. The mosquito repellent tablet 15 is detachably engaged in the protective cover 12 and can be in close contact and connection with the heating and heat-insulating assembly 14. The mosquito repellent tablet 15 is subjected to a mosquito repelling operation through the heating and heat-insulating assembly 14, such that the mosquito repellent in the mosquito repellent tablet 15 is heated and volatilizes to perform a mosquito repelling operation. The key assembly 17, the charging interface 18 and the indicator light assembly 19 are separately disposed on the circuit board 13 and penetrate through the housing assembly 11. The switch and the heating temperature are set through the key assembly 17, the battery assembly 16 is charged through the charging interface 18, and the remaining power of the battery assembly 16 is displayed in real time through the indicator light assembly 19.

Referring to FIG. 1 to FIG. 4, in this embodiment, the housing assembly 11 includes a first housing 111, a second housing 112, and a mounting member 113. The first housing 111 is a hollow cavity with one end opened. The second housing 112 is fixedly disposed on the first housing 111, and the first housing 111 and the second housing 112 form a closed hollow cavity, in which the circuit board 13, the heating and heat-insulating assembly 14, and the battery assembly 16 are fixedly disposed, respectively. The mounting member 113 is disposed on one side of the first housing 111 opposite to the second housing 112, and the mounting member 113 facilitates the hanging operation of the electric heating mosquito repeller 10. Specifically, the mounting member 113 may be a snap-fit member or an adsorption member. In this embodiment, the mounting member 113 is a snap-fit member. A covering 114 is wrapped outside the housing assembly 11, and the performance of the connection portion between the first housing 111 and the second housing 112 is enhanced through the covering 114.

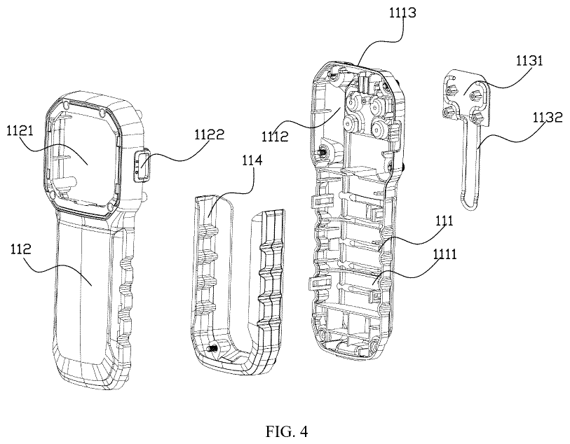

Referring to FIG. 4, specifically, a first accommodating cavity 1111 and a second accommodating cavity 1112 are disposed in the first housing 111, respectively. The battery assembly 16 is disposed in the first accommodating cavity 1111, and the circuit board 13 and the heating and heat-insulating assembly 14 are disposed in the second accommodating cavity 1112, respectively. A plurality of first through holes 1113 are provided on the side of the first housing 111, and the charging interface 18 and the indicator light assembly 19 penetrate through the housing assembly 11 through the corresponding first through holes 1113, respectively. Specifically, a second through hole 1121 is disposed throughout the position, corresponding to the heating and heat-insulating assembly 14, on the second housing 112. The heating and heat-insulating assembly 14 penetrates through the second housing 112 through the second through hole 1121 and is flush with the outer surface of the second housing 112. A key hole 1122 is provided on the side of the second housing 112, and the key assembly 17 penetrates through the housing assembly 11 through the key hole 1122. In this embodiment, the mounting member 113 includes a fixing plate 1131 and a latch 1132. The fixing plate 1131 is fixedly disposed on the first housing 111. The latch 1132 is snap-fitted between the fixing plate 1131 and the first housing 111. The latch 1132 facilitates the hanging operation of the electric heating mosquito repeller 10.

Referring to FIG. 1 to FIG. 3, in this embodiment, a neck 121 is disposed throughout the protective cover 12. The mosquito repellent tablet 15 is detachably engaged in the neck 121. The protective cover 12 is also provided with a plurality of hollow grooves 122, and the volatile mosquito repellent generated through heating the mosquito repellent tablet 15 by the heating and heat-insulating assembly 14 is diffused through the plurality of hollow grooves 122.

Referring to FIGS. 1, 2, 3 and 6, in this embodiment, the circuit board 13 is electrically connected to the heating and heat-insulating assembly 14, the battery assembly 16, the key assembly 17, the charging port 18, and the indicator light assembly 19, respectively. The control technologies used are all existing technologies, so the specific control process and product models are not described here, as long as they meet the requirements of this application. In some embodiments, a wireless communication module 131 is disposed on the circuit board 13, and the wireless communication module 131 can be wirelessly connected to an electronic terminal, such that the electric heating mosquito repeller 10 can be wirelessly controlled through an application or applet on the electronic terminal. Specifically, the wireless communication module 131 may use one or more of a Bluetooth wireless communication module, a WiFi wireless communication module, a 4G wireless communication module and a 5G wireless communication module; and preferably, the wireless communication module 131 uses a Bluetooth wireless communication module.

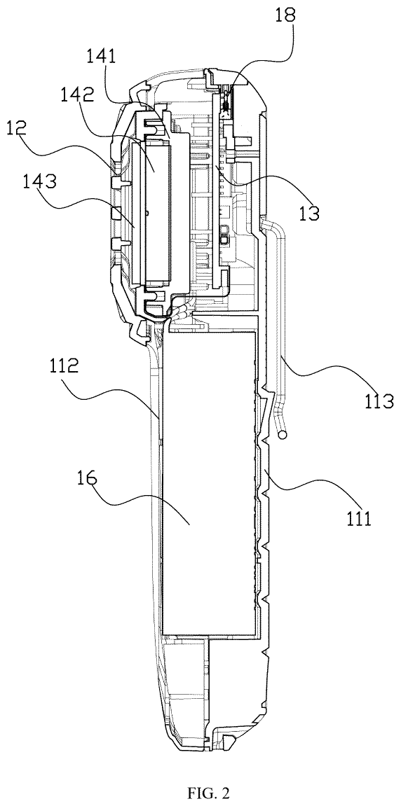

Referring to FIGS. 2, 3 and 5, in this embodiment, the heating and heat-insulating assembly 14 includes a heat-insulating chamber 141, a heat-insulating layer 142 and a heating member 143. The heat-insulating chamber 141 is a hollow cavity with one end opened, and is fixedly disposed in the second cavity 1112. The heat-insulating layer 142 and the heating member 143 are tightly attached and fixedly disposed in the heat-insulating chamber 141 in sequence. The mosquito repellent tablet 15 is detachably and tightly attached to one side of the heating member 143 and arranged oppositely to the heat-insulating layer 142. The heat-insulating chamber 141 functions in reducing air convection, thereby improving the heat-insulating effect of the heat-insulating layer 142 and the heating efficiency of the heating member 143 to a certain extent. The heat-insulating layer 142 is tightly attached to the heating member 143 and completely covers the heating member 143, which is used to reduce the heat dissipation of the side, opposite to the heat-insulating layer 142, of the heating member 143, to the maximum extent. In this embodiment, the heat-insulating layer 142 includes glass fiber wool and aluminum foil that are disposed in sequence. The glass fiber wool is tightly attached to the heating member 143, which greatly reduces the conduction of heat on the back side of the heating member 143. The aluminum foil can effectively reduce the heat on the back side of the heating member 143 and perform heat dissipation in a form of thermal radiation.

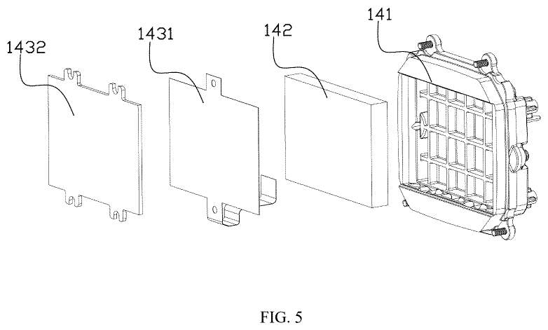

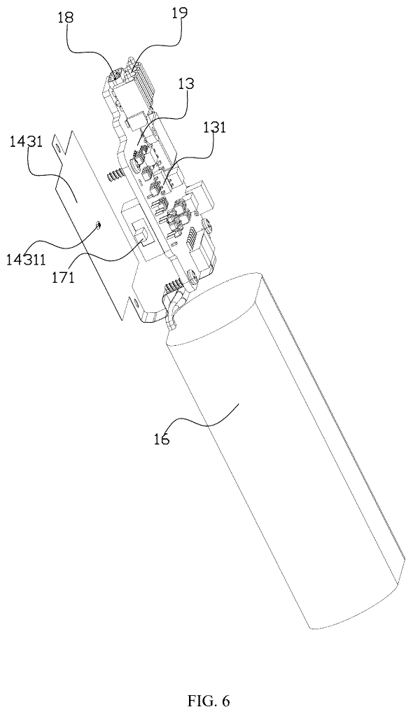

Referring to FIG. 5 and FIG. 6, in this embodiment, the heating member 143 includes a heating film 1431 and a heat-conducting plate 1432. The heating film 1431 is fixedly disposed between the heat-insulating layer 142 and the heat-conducting plate 1432. The heat-conducting plate 1432 can be in close contact and connection with the mosquito repellent tablet 15. The heat generated by the heating film 1431 is transferred to the mosquito repellent tablet 15 through the heat-conducting plate 1432 for a heating operation. In this embodiment, the heating film 1431 is a thin film with a metal foil or a metal wire as an inner conductive heating element. After the power is turned on, the temperature of the heating film 1431 will continue to rise, and then the generated heat will be transferred to the heat-conducting plate 1432 and the mosquito repellent tablet 15 in sequence. The size of the heating film 1431 is smaller than that of the heat-conducting plate 1432. In other embodiments, the heating member 143 may be a whole, or may be composed of a plurality of different heating components. Specifically, the heating member 143 may also be a ceramic heating element or a graphene heating element. In this embodiment, a temperature-controlled resistor 14311 is attached to the heating film 1431, and the temperature of the heating film 1431 is monitored in real time through the temperature-controlled resistor 14311.

Referring to FIG. 1 to FIG. 3, in this embodiment, the mosquito repellent tablet 15 is of a gasket structure impregnated with a mosquito repellent, which can volatilize the agent after being heated by the heating member 143 to achieve the mosquito repeller function. The battery assembly 16 is a polymer lithium-ion battery. In this embodiment, the key assembly 17 includes a key body 171 and a key housing 172. The key body 171 is fixedly disposed on the circuit board 13. The key housing 172 is disposed on the key body 171 and penetrates through the housing assembly 11 through the key hole 1122. Preferably, the key housing 172 is made of a silicone material, and is in sealing contact and connection with the key hole 1122, thereby improving the waterproof performance of the housing assembly 11 to a certain extent. In this embodiment, the charging interface 18 may be a Micro USB interface, a Type C interface, or a Lightning interface. Preferably, the charging interface 18 is a Type C interface. Specifically, a waterproof plug 181 is detachably disposed on the charging interface 18, the waterproof plug 181 is disposed on the housing assembly 11 at one end thereof, and the charging interface 18 is protected by the waterproof plug 181.

It should be noted that the specific working process of the electric heating mosquito repeller 10 of the present disclosure is as follows: the heating member 143 generates heat to heat the mosquito repellent tablet 15 disposed thereon, such that the mosquito repellent on the mosquito repellent tablet 15 volatilizes, thereby achieving a mosquito repelling operation. The heating member 143 is subjected to the heat-insulating operation by the cooperation of the heat-insulating chamber 141 and the heat-insulating layer 142, such that most of the heat of the heating member 143 is only transferred to one side of the mosquito repellent tablet 15, thereby reducing the heat waste of the heating member 143 to a large extent and improving the endurance of the electric heating mosquito repeller 10 to a certain extent. At the same time, the battery assembly 16 is charged through the charging interface 18, the remaining power of the battery assembly 16 is conveniently observed in real time through the indicator light assembly 19, and the multi-gear heating setting is performed through the key assembly 17, corresponding to different target heating temperatures.

Each technical feature of the above embodiments may be combined freely. For simplicity of description, not all possible combinations of each technical solution in the embodiments are described. However, any combination of these technical features shall fall within the scope recorded in the specification without conflicting.

The above embodiments only express some implementation modes of the present disclosure and are specifically described in detail and not thus understood as limits to the patent scope of the present disclosure. It is to be pointed out that those of ordinary skill in the art may further make a plurality of variations and improvements without departing from the concept of the present disclosure and all of these fall within the protection scope of the present disclosure. Therefore, the scope of patent protection of the present disclosure should be subject to the appended claims.

What is claimed is:

1. An electric heating mosquito repeller, comprising:
a housing assembly;
a protective cover fixedly disposed on the housing assembly;
a heating and heat-insulating assembly fixedly disposed throughout the housing assembly and disposed directly below the protective cover; and
a mosquito repellent tablet detachably engaged in the protective cover and able to be in close contact and connection with the heating and heat-insulating assembly, the mosquito repellent tablet being heated by the heating and heat-insulating assembly;
wherein the heating and heat-insulating assembly comprises a heating member that is fixedly disposed throughout the housing assembly and a heat-insulating layer that is fixedly disposed on one side of the heating member, and wherein the mosquito repellent tablet is detachably and tightly attached to the other side of the heating member opposite to the heat-insulating layer.

2. The electric heating mosquito repeller according to claim 1, wherein the heating and heat-insulating assembly further comprises a heat-insulating chamber that is a hollow cavity with one end opened; the heat-insulating chamber is fixedly disposed in the housing assembly; and the heat-insulating layer and the heating member are fixedly disposed in the heat-insulating chamber in sequence.

3. The electric heating mosquito repeller according to claim 1, wherein the heat-insulating layer comprises glass fiber wool and aluminum foil that are disposed in sequence; and the glass fiber wool is tightly attached to the heating member.

4. The electric heating mosquito repeller according to claim 3, wherein the heating member comprises a heating film and a heat-conducting plate; the heating film is fixedly disposed between the heat-insulating layer and the heat-conducting plate; and the heat-conducting plate is able to be in close contact and connection with the mosquito repellent tablet.

5. The electric heating mosquito repeller according to claim 4, wherein the heating film is a thin film with a metal foil or a metal wire as an inner conductive heating element; and a size of the heating film is smaller than a size of the heat-conducting plate.

6. The electric heating mosquito repeller according to claim 5, wherein a temperature-controlled resistor is attached to the heating film; and the temperature of the heating film is monitored in real time by the temperature-controlled resistor.

7. The electric heating mosquito repeller according to claim 1, wherein the heating member is a ceramic heating element or a graphene heating element.

8. The electric heating mosquito repeller according to claim 1, wherein the housing assembly comprises a first housing and a second housing that are fixedly connected and form a closed hollow cavity and a mounting member that is disposed on the other side of the first housing opposite to the second housing.

9. The electric heating mosquito repeller according to claim 8, wherein the mounting member is a snap-fit member or an adsorption member.

10. The electric heating mosquito repeller according to claim 9, wherein the mounting member comprises a fixing plate that is fixedly disposed on the first housing and a latch that is engaged between the fixing plate and the first housing.

11. The electric heating mosquito repeller according to claim 8, wherein the electric heating mosquito repeller further comprises a circuit board, a battery assembly and a key assembly; the circuit board and the battery assembly are fixedly disposed in the housing assembly, respectively; the circuit board is electrically connected to the heating and heat-insulating assembly, the battery assembly and the key assembly, respectively; and the key assembly is disposed on the circuit board and penetrates through the housing assembly.

12. The electric heating mosquito repeller according to claim 11, wherein a wireless communication module is disposed on the circuit board, and a wireless connection with an electronic terminal is established through the wireless communication module; and the wireless communication module uses one or more of a Bluetooth wireless communication module, a WiFi wireless communication module, a 4G wireless communication module and a 5G wireless communication module.

13. The electric heating mosquito repeller according to claim 11, wherein the battery assembly is a polymer lithium-ion battery.

14. The electric heating mosquito repeller according to claim 11, wherein the key assembly comprises a key body and a key housing; the key body is fixedly disposed on the circuit board; and the key housing is disposed on the key body and penetrates through the housing assembly.

15. The electric heating mosquito repeller according to claim 11, wherein the electric heating mosquito repeller further comprises a charging interface and an indicator light assembly; the charging interface and the indicator light assembly are separately disposed on the circuit board and penetrate through the housing assembly.

16. The electric heating mosquito repeller according to claim 15, wherein the charging interface is a Micro USB interface, a Type C interface or a Lightning interface.

17. The electric heating mosquito repeller according to claim 16, wherein a waterproof plug is detachably disposed on the charging interface, and the waterproof plug is disposed on the housing assembly at one end thereof.

18. The electric heating mosquito repeller according to claim 11, wherein a first accommodating cavity and a second accommodating cavity are disposed in the first housing, respectively; the battery assembly is disposed in the first accommodating cavity; and the circuit board and the heating and heat-insulating assembly are disposed in the second accommodating cavity, respectively.

19. The electric heating mosquito repeller according to claim 1, wherein a neck is disposed throughout the protective cover, and the mosquito repellent tablet is detachably engaged in the neck;
and the protective cover is also provided with a plurality of hollow grooves.

20. The electric heating mosquito repeller according to claim 1, wherein the mosquito repellent tablet is of a gasket structure impregnated with a mosquito repellent.
